(19) United States
(12) Patent Application Publication
(10) Pub. No.: US 2012/0118603 A1
(43) Pub. Date: May 17, 2012

(54) OVER AIR-BARRIER ELECTRICAL BOX

(76) Inventors: Robert Anthony FUNK, Surrey (CA); Anthony Isaac Funk, Surrey (CA)

(21) Appl. No.: 12/945,695

(22) Filed: Nov. 12, 2010

(51) Int. Cl. H01H 9/02

(52) U.S. Cl. 174/53

(57) ABSTRACT

The invention disclosed and claimed here includes an electrical box and a system for mounting the electrical box to the exterior of a structure. When used with a mating rain shield, the invention provides a water-proof means for mounting electric devices on the exterior of structures. The electrical box can be used as a primary electrical box or it can be used as an extension of a pre-existing electrical box. The invention includes a face-plate that is attached to the electrical box. The electrical box is universal in two respects. First, it can be mounted to and used as an extension for a wide variety of pre-existing electrical boxes, and second, by employing a variety of face-plates, the electric box can be adapted to receive many different types of electric devices, such as plugs, sockets, lamps, lights, and electric accessories.

### BACKGROUND

The field of the invention is electric junction boxes, particularly those used in exterior applications in conjunction with rain shields and rain-shielded mounting boxes.

The term “electrical box” or, alternatively, “box” is used herein as is standard in the art, which is to say a housing within which one or more electrical connections are made. While many electrical boxes are rectangular, neither the term “electrical box” nor the invention is restricted to rectangular structures. The terms “back”, “bottom” and “back/bottom” when used in reference to a surface or side of the electrical box mean the same thing. If the box is being held on one's hand and one is looking into the box, the term “bottom” is more descriptive. If the box is mounted vertically for use, the term “back” is more descriptive.

The term “electrical device” includes any device that may be mounted on the exterior of a building and that is powered by, controls, or otherwise interacts with electricity, including, without limitation lights, lamps, plugs, switches, and sockets.

Electrical devices mounted on the exteriors of buildings present certain challenges and problems, most of which are associated with water. Because the wires feeding electricity to exterior devices normally originate from the interior of the building, it is necessary to penetrate the exterior wall and the protective sheathing or cladding to produce a hole for the wire. Even when such breaches are done carefully and are properly sealed, over years or decades of exposure to air and water, the sealing seal deteriorates and rainwater gains access to the interior of the wall, resulting in rotting, electrical malfunction, and other problems, most of which are expensive to repair and some of which can be dangerous.

In our previous U.S. Pat. No. 7,358,440 and US Patent Application 2008/0196938-A1 we disclosed a rain shield that may be used with the present invention to overcome the foregoing problems. The background sections of those documents may be consulted for a more comprehensive discussion of problems associated with electrical devices and boxes mounted on the exterior of a building. Those background sections are incorporated herein by reference. Disclosed herein is a universal electrical box that may be used in conjunction with a rain shield of the type we previously disclosed.

### SUMMARY OF THE INVENTION

The invention includes a universal electrical box that is universal in the sense that 1) it can be mounted to and extend a wide variety of pre-existing electrical boxes, and 2) it can be used to mount a wide variety of electrical devices to the exterior of buildings.

The invention, when used with an appropriate rain shield, provides a water-tight device for mounting electrical devices on the exterior of buildings. Preferably, the invention is mounted over the air-barrier of the building to which the electric device is to be attached.

The electrical box of the invention may be made of a suitable material such as virgin polypropylene.

The electrical box may be provided with attachment means for attaching the box to a building's surface; for instance, attachment holes for receiving screws.

The electrical box may be provided with a mounting means for mounting the box on a pre-existing electrical box and thereby acting as an extension of the pre-existing box. Such mounting means may be, for instance, mounting holes for receiving screws.

The electrical box is provided with at least one access opening for allowing wires from the building to access the interior of the box. The access opening may be protected by a knock-out prior to use.

The electrical box is provided with a face-plate and a means for mounting an electrical device to the face-plate; for instance, face-plate mounting holes for receiving screws. The face-plate has an opening therein so that wires from the electric device can have access to the interior of the electrical box.

The electrical box may include a grounding strip and a grounding screw for grounding the electric device.

The invention may include a sealing means for excluding water from the interior of the electrical box and electric device. The sealing means may be, for instance, a sealant, O-ring, or gasket placed between the electric device and the face plate.

### BRIEF DESCRIPTION OF THE DRAWINGS

FIG. 1 is a plan view of an electrical box according to the invention.

FIG. 2 is a cross-section of the electrical box of FIG. 1.

FIGS. 3a and 3b are, respectively, front and rear plan views of covers used in conjunction with the electrical box of FIG. 1 when the electrical box is used to house a plug.

FIG. 4 is a plan view of the cover of FIG. 3 attached to the electrical box of FIG. 1.

FIGS. 5a and 5b are, respectively, front and rear plan views of covers used in conjunction with the electrical box of FIG. 1 when the electrical box is used to house an exterior light.

FIG. 6 is a cross-section of an exterior wall of a building upon which the invention is mounted, showing how the electrical box is mounted over an air-barrier.

FIG. 7 is a cross-section of an exterior wall of a building upon which the invention is mounted, showing how the electrical box of the invention is used as an extension of an existing electrical box.

### DETAILED DESCRIPTION OF THE INVENTION

### Structure

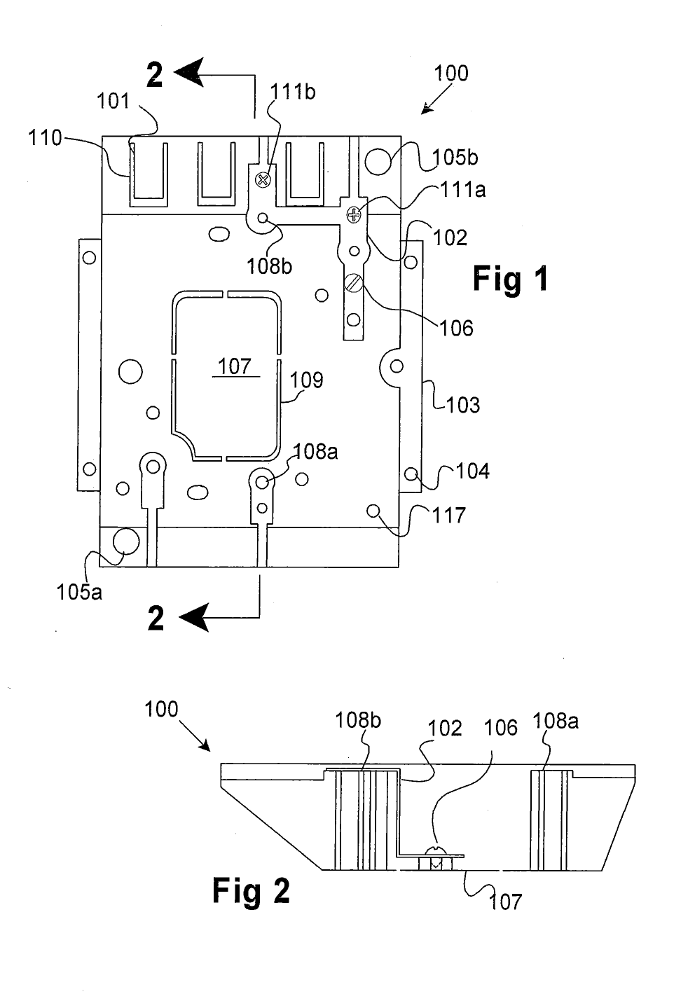

Referring first to FIGS. 1 and 2 an electrical box 100 according to the invention is illustrated without a cover or face plate. The electrical box 100 is constructed from any suitable material. Although a variety of materials may be employed without adversely affecting the function, novelty, or objectives of the invention, a preferred material is a plastic material, and more specifically, virgin polypropylene. The box 100 may be manufactured to meet the specifications of a particular application, but generally a rectangular box is preferred, being approximately 9.5 cm in its shortest dimension, referred to herein as its width; approximately 13.8 cm in its longest dimension, referred to herein as its length; and have a depth of approximately 2.5 cm.

The electrical box 100 is provided with a plurality of attachment holes, one of which is designated 104, for attaching the box 100 to the exterior surface of the building, as will be described below. These attachment holes may be conveniently located on the outer aspect of the box 100, for instance on an elongate strip or flange 103 as shown.

The electrical box 100 is provided with a plurality of mounting holes, one of which is designated 117, for mounting the box 100 on pre-existing electrical boxes when it is desirable to provide an extension to the pre-existing electrical box, as described in detail below. The term “pre-existing electrical box” as used in this description and the claims refers to an electrical box that is mounted on the subject structure and to which the invention is attached. These mounting holes 117 are generally located on the bottom/back of the electrical box 100 in positions that are predetermined in order for the electrical box 100 to match the mounting holes of a wide variety of existing electrical boxes for which the invention can act as an extension. With judicial placement of the mounting holes the electrical box 100 can serve as an extension for 98% of approved existing electrical boxes. This is one example of how the invention be accurately considered to be “universal.” When the term “universal extension” is used herein, it refers to this feature of being able to serve as an extension to more than one type of pre-existing electrical box.

With respect to this universal extension feature, the invention includes a number of access openings to allow wires to enter the box 100 from a number of different types of sources. These access openings are provided with knock-outs. One example of these openings is a peripheral opening shown at 110, with knock-out 101. These peripheral openings are positioned near the edge of the box 100 to allow wires to access the box 100 from above, below, or the side depending on how the box 100 is mounted. A central opening 109 is provided in the back/bottom of the box 100, with central knock-out 107. This opening allows access for wires entering from behind the box 100.

The electrical box 100 shown in FIGS. 1 and 2 includes face-plate attachment holes 105a, 105b used to attach a face plate to the box 100. The embodiment shown has two such holes; however, the scope of the invention includes any number that is deemed satisfactory for holding a face-plate to the box 100.

Electric device mounting holes 108a, 108b are provided for mounting exterior electric devices such as plugs and light fixtures to the electrical box 100. These electric device mounting holes are spaced apart and extend upwards from the bottom of the box 100 a sufficient distance to accommodate the desired electric device within the box 100. For example, by spacing holes 108a and 108b apart by substantially 8.3 cm. and by having the mounting holes substantially 2.8 cm above the bottom of the box 100, a standard double electrical plug can be mounted on the box 100.

A metallic grounding strip 102 is built into the electrical box 100 or attached thereto, for instance, by screws 111a, 111b. Grounding screw 106 is provided for grounding the electrical device mounted on the box 100.

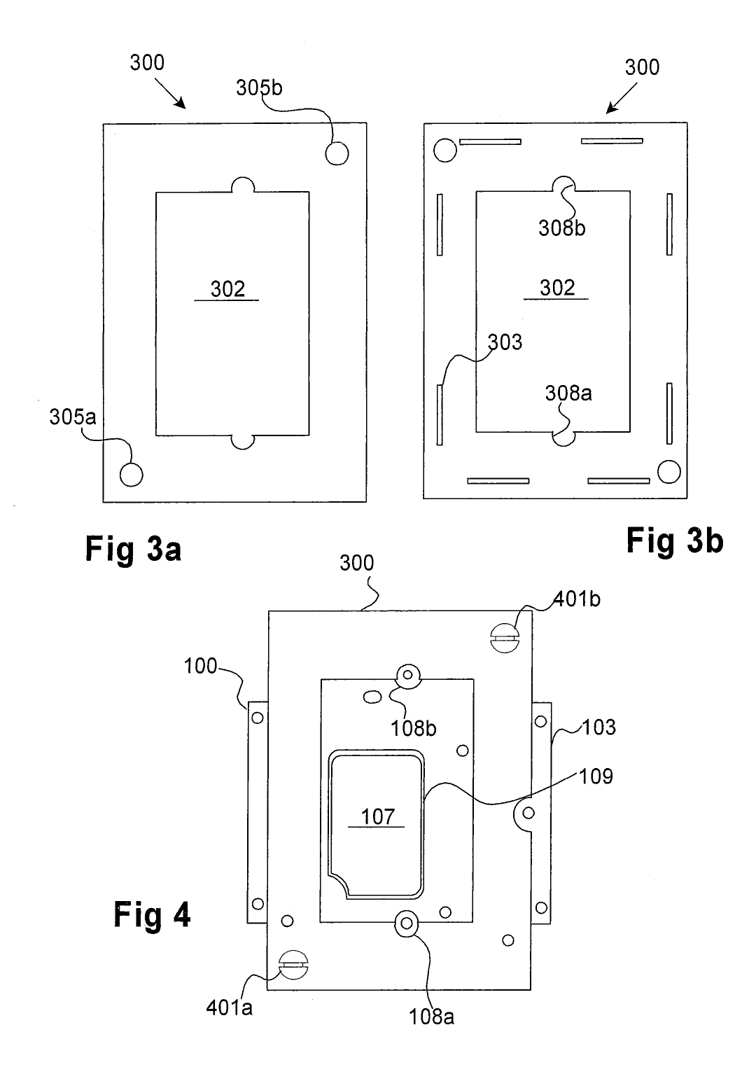

Referring now to FIGS. 3a and 3b, an example of a face-plate 300 for the electrical box 100 is illustrated. The face-plate is the type that would be used to mount an electrical plug to the invention. The plug is not shown. The figures show the front of the face-plate, FIG. 3a, which faces away from the structure when mounted on the electrical box 100, and the rear of the face-plate, FIG. 3b, which faces toward the structure when mounted on the electrical box 100. The outer dimensions of the face-plate are substantially equal to the dimensions of the electrical box 100, neglecting the flanges 103.

The face-plate includes an opening 302 that accommodates the electrical device that will be mounted on the box 100. The opening may include recesses 308a, 308b that allow access to electrical device mounting holes 108a and 108b when the face-plate is attached to the box 100.

Face-plate holes 305a, 305b match face-plate attachment holes 105a, 105b on the box 100 so that the face-plate can be attached to the box 100 by means of screws, as shown in FIG. 4.

The rear of the face-plate includes alignment rails, one of which is designated 303. These rails may be provided as a plurality of short ridges, as shown in FIG. 3b, or they may be longer, continuous rails on two or more sides. The function of the rails is to facilitate alignment of the face-plate with the electrical box 100 and to provide a modicum of tension between the face-plate and the box 100 in order to hold the face-plate snugly on the box 100.

Referring now to FIG. 4, the face-plate 300 is illustrated as attached to the electrical box 100 by means of screws 401a, 401b. Most of the interior of the box 100 is, of course, obscured by the face-plate, but central opening 109 and central knock-out 107 can be seen.

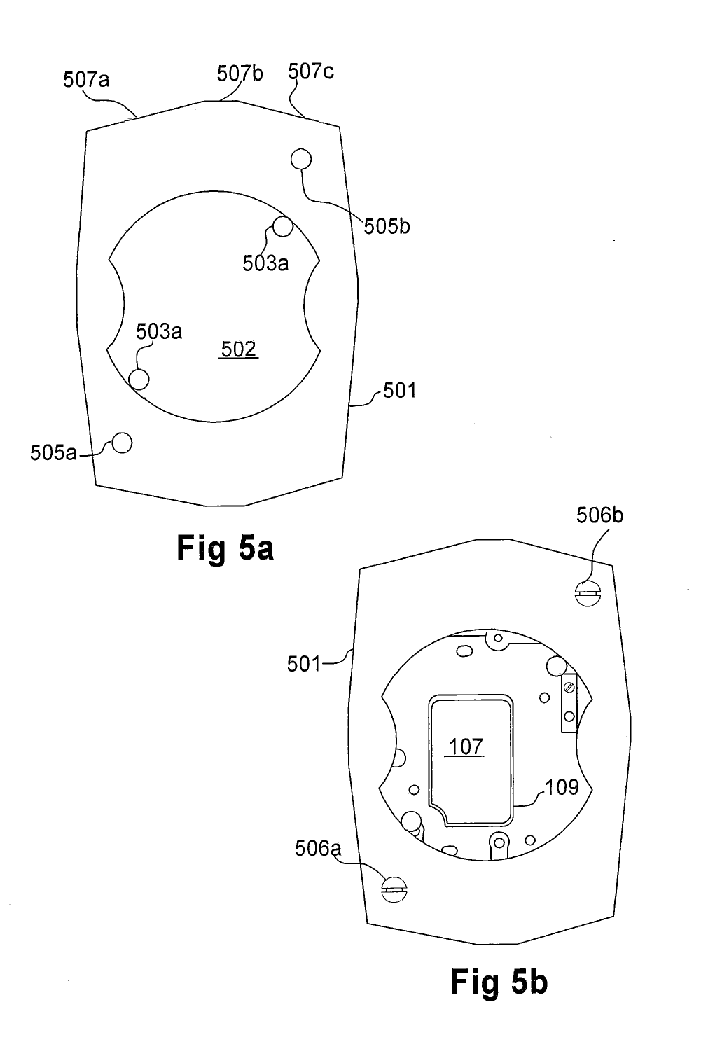

FIGS. 5a and 5b illustrate a different embodiment of the face-plate—one used to mount a light fixture. The light fixture is not shown. FIG. 5a shows just the face-plate, and FIG. 5b shows the face-plate attached to the electrical box 100, which is obscured by the face-plate.

The precise dimensions and shape of the light fixture face-plate depend on the light fixture. Generally, the light fixture face-plate has a circular opening 502. The light fixture face-plate has mounting holes 505a, 505b spaced as for the plug-type face-plate so that the face-plate can be attached to the electrical box 100 with screws 506a, 506b. Holes 503a, 503b are provided for attaching the light fixture to the electrical box 100.

The plug and the light fixture face-plates are to be viewed as but two of many examples of the way the same electrical box of the invention can be adapted to serve a wide variety of electrical devices because variable face-plates act as adapters for various electrical devices. This is the second way in which the electrical box of the invention is universal—it has the potential to serve as a base for many different types of electrical devices. When the term “universal mounting” is used in this description and the claims, it refers to the potential of the invention to serve as a base for many different types of electric devices.

### Operation and Functions

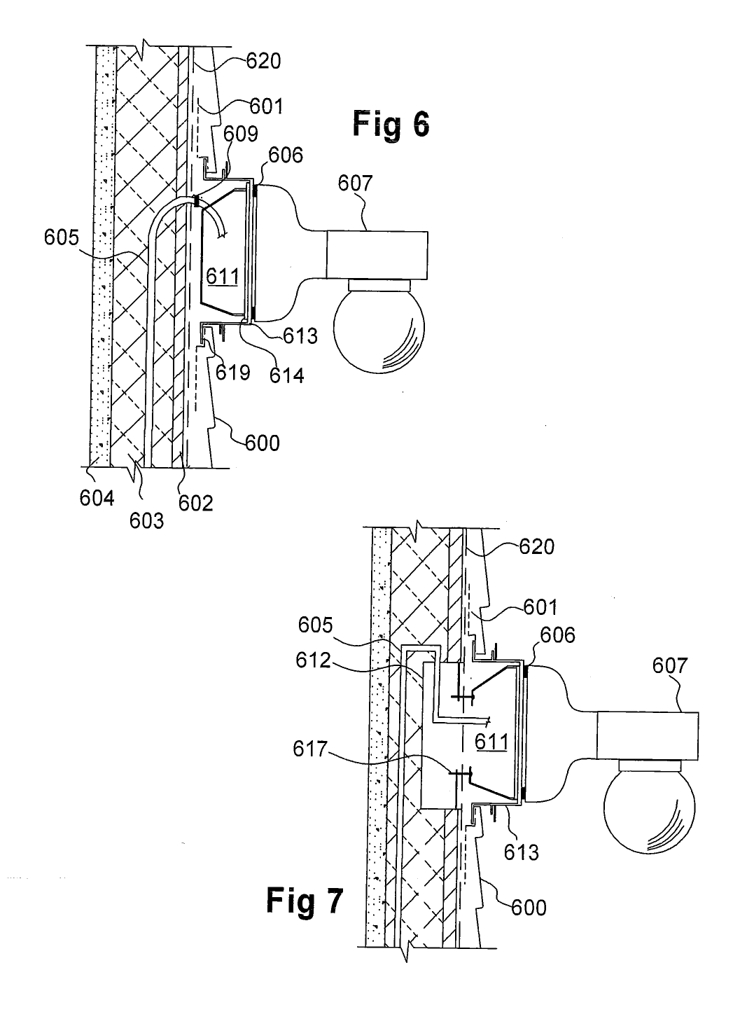

FIGS. 6 and 7 illustrate how the invention may be used to provide a water-proof base and electrical box for exterior electric devices. Both figures show a typical exterior wall in cross-section. The interior side of the wall is sheet rock 604 or other interior wall surface. An air space filled with insulation 603 is situated between the sheet rock 604 and sheathing 602. Often a vapor barrier (not shown) will line the exterior side of the sheet rock 604. In standard construction an air barrier is formed by means of air barrier membrane 620 placed over the sheathing 602. Siding 600 or other exterior cladding completes the wall. A wire 605 originating inside the structure provides current to the electric device.

FIG. 6 with reference to FIG. 1, illustrates how the invention can be used in conjunction with an exterior light fixture 607 to provide a safe and water-proof device where there is no pre-existing electrical box, such as, for example, in new construction. Wire 605 is fed through a hole in the sheathing 602 and then through one of the access openings 110 of the electrical box 611 from which the knock-out 101 has been removed. The wire hole is sealed with an appropriate sealant 609. The box 611 is secured to the sheathing by means of screws inserted through the attachment holes 104. The box 611 is preferably mounted exterior to air barrier membrane 620, which is what is meant when referring to the electrical box as an “over air-barrier” electrical box. Depending upon the specific embodiment, the face-plate 614 may be attached to the electrical box 611 prior to securing the box to the sheathing or after. For a plug, the face-plate remains attached throughout the mounting procedure because the face-plate does not prevent access to the attachment holes 104. In other instances, the face-plate is larger and must be attached to the box 611 after the box is attached to the sheathing.

After the electrical box 611 is attached to the sheathing 602 over the air barrier membrane 620, a rain shield 613 is placed over the electrical box and secured to the sheathing by means of a rain shield nailing flange 619 that surrounds the periphery of the rain shield. The nailing flange 619 may be sealed to the air barrier membrane 620 by self-adhesive seal 601 or other functionally equivalent means.

Siding 600 is then applied to the sheathing so that the siding covers the nailing flange 619 of the rain shield 613 and comes into close proximity to the sides of the rain shield. Preferably, the siding 600 should be installed with no more than a ¼″ gap between the siding and the side of the rain shield 613. If the electrical box 611 and rain shield 613 are chosen to mate properly, it is not necessary that the siding form a water-tight seal with the rain shield, for the rain shield will divert any water away from the interior of the box. A trim ring (not shown) may then be attached to the rain shield box, as described in U.S. Pat. No. 7,358,440, for aesthetics and for extra rain-protection.

At this point the wire 605 is connected to the light fixture and the light fixture is mounted to the electrical box 611 using the mounting holes provided on the electrical box. A gasket 606, O-ring, sealant, or other sealing device is placed between the base of the light fixture and the face-plate 614 prior to mounting the light fixture to the electrical box. In the case of a plug, the gasket is placed between the face-plate and the plug cover plate.

### Embellishments, Variations, and Details

### Extension Box Function and Structure

FIG. 7 shows the optional use of the electric box of the invention as an extension for a pre-existing electrical box. Most of the structures and relationships are the same as disclosed above with respect to FIG. 6; however, in FIG. 7 pre-existing electrical box 612 is already mounted in the wall. This is a common situation where an electric device is being replaced and the original electrical box is in usable condition. In such situations, it is often easiest to bring the wire 619 through the back of the invention, and this is easily accomplished by removing protective central knock-out 107, thereby leaving central opening 109 as an access opening for the wire.

As a result of judicious placement of the plurality of mounting holes 117 in the bottom of the electrical box 611, the electrical box can be mated with and extend a very wide variety of existing electrical boxes simply by using attachment screws 617 that pass through the bottom of the extension electrical box 611 and into the mounting holes of the existing electrical box. The rain shield box and trim ring are then attached as described above to make a water-proof extension for the electric device.

### Choice of Rain Shield

In order to form a water-tight device, the electrical box of the invention should be used in conjunction with a rain shield that will mate with the electrical box properly. For instance, the openings and access holes of the electrical box must align with those of the rain shield in order to permit the wires of the electric device to access the interior of the box. Furthermore, the rain shield must divert rain water from the siding, particularly at the top surface, so that the water does not gain access to the electrical box through capillary action—a rain shield that has sloped shoulders and/or other features to divert rain water is necessary to ensure a water-tight attachment. Preferably this can be achieved without taping or sealing the edges of the rain shield to the siding because such sealing devices eventually fail and must be redone periodically. A rain shield appropriate for this purpose has been described in U.S. Pat. No. 7,358,440 and is marketed as “Third Wave Mounting Block™” by VSA Enterprises Inc. of Langley, B.C.

### Rotational Orientation Device

When mounting the electric box 611 to the sheathing 602, it can be difficult to be certain that the box is plumb and square so that the electrical device will align properly with the siding. This problem is addressed by a face-plate as shown in FIGS. 5a and 5b. As can be seen, the face plate has facets, or sloped sections of one or more of the periphery edges. The facets of the top edge are shown as 507a, 507b, and 507c. These facets allow a degree of rotational play for orienting the rain shield properly once it has been placed over the electrical box and while it is being attached to the sheathing. The preferred amount of play is about 12°, but this is merely a guideline.

### SUMMARY

The invention may be summarized as an electrical box that is universal in two respects. First, it can be used as an extension box for a wide variety of approved electrical boxes, and, second, it can be used as a base electrical box for a wide variety of exterior electric devices. The electrical box is preferably used in conjunction with a rain shield to provide a water-proof mounting system for exterior electric devices, such as, but not limited to, plugs and lights.

The invention has been described here with respect to particular, preferred embodiments. Those of skill in the art will recognize that the scope of the invention obviously extends beyond these particular embodiments to include obvious and equivalent manifestations of the invention not explicitly described herein.

What is claimed is:

1. An electrical box (100) comprising:
a. mounting means (117, 617) for mounting said electrical box (100) to a pre-existing electrical box (612), wherein said electrical box (100) functions as an extension of said pre-existing electrical box (612);
b. at least one access hole (109) for permitting at least one wire to access an interior of said electrical box (100);
c. a face-plate (300);
d. face-plate attachment means (105b, 401b) for attaching said face-plate (300) to said electrical box (100); and,
e. electrical device mounting means (108a, 108b) for attaching an electric device to said electrical box (100).
